(19) United States
(12) Patent Application Publication
(10) Pub. No.: US 2022/0134164 A1
(43) Pub. Date: May 5, 2022

(54) BELAY DEVICE FOR ASSISTED CLIMBING

(71) Applicant: ABEO, RIOZ (FR)

(72) Inventor: Jérôme BOURQUARD, BESANCON (FR)

(21) Appl. No.: 17/431,552

(22) PCT Filed: Feb. 18, 2020
(86) PCT No.: PCT/FR2020/050291

§ 371 Date: Aug. 17, 2021

(30) Foreign Application Priority Data
Feb. 19, 2019 (FR) 1901643

(51) Int. Cl. A63B 21/00; A63B 69/00; A62B 35/00; A62B 1/06; A63B 71/00; A63B 71/06

(52) U.S. Cl. CPC A63B 21/00181; A63B 69/0048; A62B 35/0093; A62B 1/06; A63B 71/0054; A63B 2220/805; A63B 2071/0081; A63B 2071/0638; A63B 2071/0666; A63B 2220/34; A63B 71/0622

(57) ABSTRACT

Disclosed is a belay device for climbing including an automatic winder including a pulley and a rope. The device includes an electric motor configured so as to apply a torque to the pulley and an encoder coupled to the pulley. The motor is controlled using the encoder according to the rotation of the pulley so as to modulate the torque applied to the pulley according to at least: —an assistance mode in which the torque applied by the servomotor to the pulley drives a pulling of the rope which assists the climber in his climb; and —a fall mode in which the torque applied by the servomotor to the pulley blocks a fall of the climber or slows it to a speed less than 3 m/s. Also disclosed is a climbing game system with virtual or augmented reality using such a belaying device.

### BACKGROUND OF THE INVENTION

### Field of the Invention

The present invention concerns the field of climbing as a physical sports activity or leisure activity.

It relates in particular to a belay brake type device having enhanced functions compared with the devices known in the state of the art.

### Description of the Related Art

The practice of climbing as a sports activity is currently developing among the general public. In order to practice this activity in complete safety, equipment is being developed enabling the climber to be belayed in simple and effective manner.

As is known, it is common to belay climber with a “top rope”, also called “top-roping”, using a rope passing via a pulley installed at the top of the route or rock climbed. One or two belayers have the responsibility of belaying the climber in case of a fall or as may be required at the time he or she descends. The rope is inserted into a belay brake connected to a harness worn by the belayer. The belay brake enables the belayer to provide slack during climbing and to brake or even lock the rope in case of a fall or descent of the climber.

Other known devices, called auto belays, enable a climber to be belayed. In very general terms, auto belays constitute means for what is referred to as dispensing rope and serve to protect a climber against falls by retracting, within the auto belay device, the slack present in the rope when the rope is not under load and by providing a braking force when the rope is loaded, such that the weight at the end of the rope is reduced in the interest of safety (typically, to prevent or brake a fall).

To provide the braking force, several systems such as a friction brake are a hydraulic damping mechanism have been used in rope dispensing devices such of auto belay type. Furthermore, the known devices are differentiated by the presence or by the absence of a clutch to engage the braking system and conversely to disengage it when the rope is not under load, the devices using a device that does not require a clutch possibly proving to be safer.

For example, document US2014048639 discloses an auto belay combining a return spring for the rope and a contactless eddy-current baking system, operating on the principle that when an electrical conductor passes through a magnetic field (or vice-versa), the relative movement induces a flow of electric currents in the conductor, which in turn induce a magnetic field that opposes the magnetic field applied.

This type of device is simple, effective and safe. Nevertheless, in the context of the development of climbing as a physical activity accessible to a wide public, or as a leisure activity for amusement, the Applicant has discovered that it could be advantageous to provide an auto belay device offering new functions. Thus, the invention relates to a belay device for climbing comprising an auto belay comprising a pulley and a rope. The device is configured such that the rope is wound or unwound according to the movements of a climber belayed by said belay device. The belay device comprises an electric motor configured so as to be able to apply a torque to the pulley and an encoder coupled to the pulley, the motor being automatically controlled by an electronic control circuit using the encoder as a function of the rotation of the pulley so as to modulate said torque applied to the pulley according to at least:
an assistance mode in which the torque applied by the motor to the pulley gives rise to traction of the rope which assists the climber in his or her climb; and
a fall mode in which the torque applied by the motor to the pulley blocks a fall of the climber or slows it to maintain it at a speed less than 3 m/s.

### SUMMARY OF THE INVENTION

The device thus provided in the invention enables a climber to be belayed, while offering an assistance function. In particular, the device makes it possible to manage both the ascent or climb of the climber and his or her fall, using a simple single system based on a motor automatically controlled using an encoder capable of characterizing the rotation of the pulley. The automatic control of the motor is implemented in at least two modes according to whether the climber is performing a climb or a descent. The device makes it possible in particular to manage the fall of the climber reliably, without recourse to a mechanical, electromagnetic or hydraulic clutch, as is the case in most known belay systems, and in addition provides a climbing assistance function. This opens the practice of sports climbing to a wide public, or enables climbing to be practiced as an amusement. A simple device, based on an automatically controlled motor, which may be a servomotor, is furthermore particularly well-adapted to centers of free climbing which are emerging today.

The motor may be automatically controlled such that the torque giving rise to the traction in the assistance mode is only applied when the encoder detects a rotation of the pulley which shows a reduction in the force applied by the rope on the pulley.

Climbing aid is thus obtained, which is active only when the climber actively climbs a face or rock. In other words, it is not a matter of reducing the weight of the user on ascending, in continuously and fixed manner, but of providing a device which adapts to the climb made, for example according to the forces exerted by the climber, or according to the dynamism of that climb.

Of course, assistance at all times is not excluded from the invention, and may be applied in certain embodiments.

The value of the torque applied by the motor to the pulley in the assistance mode may in particular be a function of the value, rate, or the speed of the reduction in the force applied by the rope on the pulley. It may be a function of a predefined calibration value of the device.

The motor may be automatically controlled such that, in the assistance mode, the speed of ascent, corresponding to the winding speed of the rope on the pulley, is substantially constant.

The device thus in particular enables adaptation to the wishes or to the morphology, in particular the weight, of the climber. The device may thus be adapted for example to a specific training program, providing for example for progress of the climber in his or her practice by reducing the level of assistance little by little. The device may be adapted to a more amusing practice of climbing, by providing a very high level of assistance enabling the user to climb almost without effort, to jump from one hold to another, or even from one face to another, etc.

The motor may be automatically controlled such that in the fall mode the torque applied to the pulley for the most part ensures a substantially uniform predefined fall speed, independently of the applied by the rope (3) on the pulley.

The motor may be automatically controlled such that in the fall mode the torque applied to the pulley enables progressive braking of the climber before ensuring a substantially uniform fall speed.

The motor, as an automatically controlled device, enables a situation of fall of the climber to be directly managed. In particular, the fall speed may be limited to a speed avoiding any risk of injury. It is accepted that a speed less than 3 m/s, in particular a speed of approximately 2 m/s, is compatible with a risk-free descent. Furthermore, in some embodiments of the invention, the automatic control of the motor may be programmed to ensure dynamic belaying of the climber, which is more comfortable and safer than sudden braking.

The motor may be directly linked to the pulley or may be linked via a synchronous mechanical transmission.

Thus, no device of clutch type is employed in the invention in its nominal operating mode. A clutch-type device or mechanical brake is only implemented, if required, in an optional degraded mode implemented for example in case of a failure in electrical supply of the device. The motor and the pulley are linked together such that the motor induces a direct drive of the pulley, or with a transmission ratio, in order to apply thereto an assistance or resistance torque.

The device may furthermore comprise a disk brake configured to be automatically actuated in case of electrical power cut of said device.

Simply by its configuration, the device may thus, in a degraded operating mode corresponding for example to an electrical power cut of the motor, ensure the safety of the climber in case of fall. The disk brake providing the climber's safety in case of electrical power failure of the device is engaged in the absence of electrical supply, and releases when the device is electrically energized.

The motor may be of brushless type and comprise a rotor bearing a series of permanent magnets and a stator bearing a set of windings.

Such a motor is reliable, little subject to wear, and enables a high mechanical torque to be obtained.

The device may comprise a mechanical system enabling movement of the auto belay, in a direction referred to as transverse, perpendicular to the general direction of extension of the rope outside the auto belay, this direction being referred to as vertical. For example, the auto belay is mounted on a rail extending in the transverse direction so as to be able to be translationally moved freely along said rail, or on an arm pivoting about an axis extending substantially in the vertical direction.

A transverse translational movement of the auto belay, which comprises in particular the pulley, makes it possible to follow the movement of the climber. This increases the comfort of use, avoids a swinging movement of the climber in case of a fall, and makes the device compatible with climbing faces of great width.

The invention also relates to a climbing system for amusement comprising a climbing structure, a virtual reality device such as headgear or glasses, a computer system configured to project, into the virtual reality device, an image applied to the structure to climb, and a belay device for climbing as described above.

The invention also relates to a climbing system for amusement comprising a climbing structure, an augmented reality device, a computer system configured to project an image onto the structure to climb, and a belay device for climbing as described above.

In a climbing system for amusement in accordance with the invention, a sensor may be configured to determine the position and attitude of a climber using said climbing system for amusement, so as to vary the image projected in the virtual reality device or on the structure to climb.

As the device provided in the invention not only enables a climber to be belayed but also enables assisted climbing, it makes it possible to envision use for amusement that differs from the common practice of climbing. By coupling the device with a virtual environment, whether generated thanks to a virtual reality device or thanks to an augmented reality device, the user may be offered a unique experience. For example, a child or an adult moving in that environment may have the impression of climbing a tree or on a building recreated virtually in accordance with the holds available on a wall or other climbing structure. This amusement activity is then carried out without effort, or even in the manner of a super hero, it being possible for the belay device according to the invention to enable performance to be achieved that is inaccessible to a human. It is possible, for example, to climb at high speed, to make jumps from hold to hold, or any other climbing experience with a sensation of reduced gravity.

Still other particularities and advantages of the invention will appear in the following description.

### BRIEF DESCRIPTION OF THE DRAWINGS

In the accompanying drawings, given by way of non-limiting example:

FIG. 1 shows, in a diagrammatic three-dimensional view, a belay device in accordance with one embodiment of the invention;

FIG. 2 shows an exploded three-dimensional view of the device of FIG. 1;

FIG. 3 shows, in a diagrammatic view, a particular embodiment of the invention and its environment of use;

FIG. 4 shows, in a diagrammatic view in three dimensions, another particular embodiment of the invention and its environment of use;

FIG. 5 shows, in a diagrammatic view in three dimensions, a climbing system for amusement, in accordance with an embodiment of another aspect of the invention.

### DESCRIPTION OF THE PREFERRED EMBODIMENTS

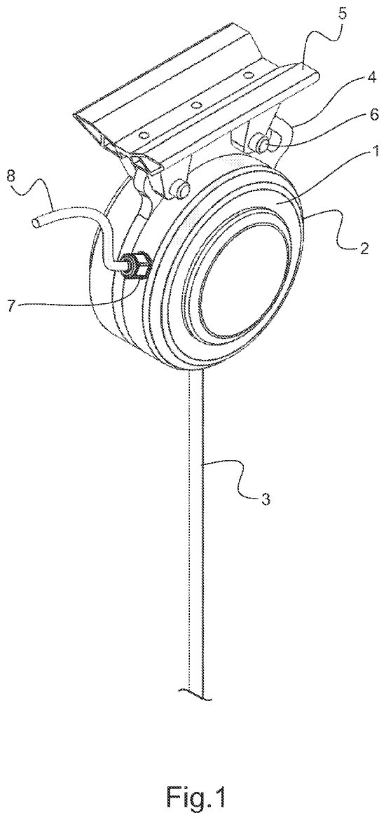

FIG. 1 shows an example of a belay device for climbing in accordance with an embodiment of the invention. This device comprises an auto belay 1, comprising a casing 2 within which a rope 3, which may be constituted by a flat belt, is wound and unwound according to need.

The belay comprises a fastening interface 4, configured to be fastened to a mounting bracket 5. In the example presented here, the device comprises the mounting bracket 5, which constitutes a fixed point capable of reliably bearing a high force, greater than the weight of the climber.

The connection between the mounting bracket 5 and the fastening interface 4 of the belay 1 is achieved in the example shown using two bolts 6.

Other mechanical connection means, for example connecting rods or pins, may of course be envisioned. For example, the device may lack any mounting bracket 5, in order to be fastened at the top of a climbing face for example using two carabiners.

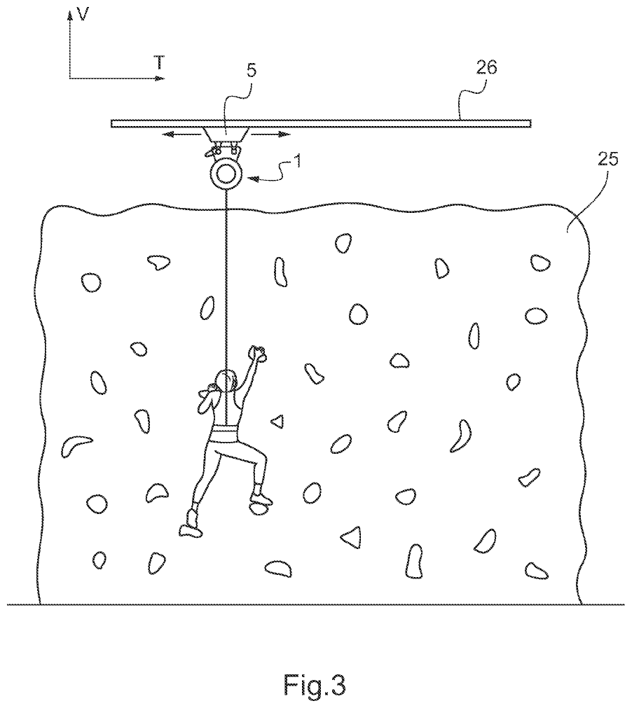

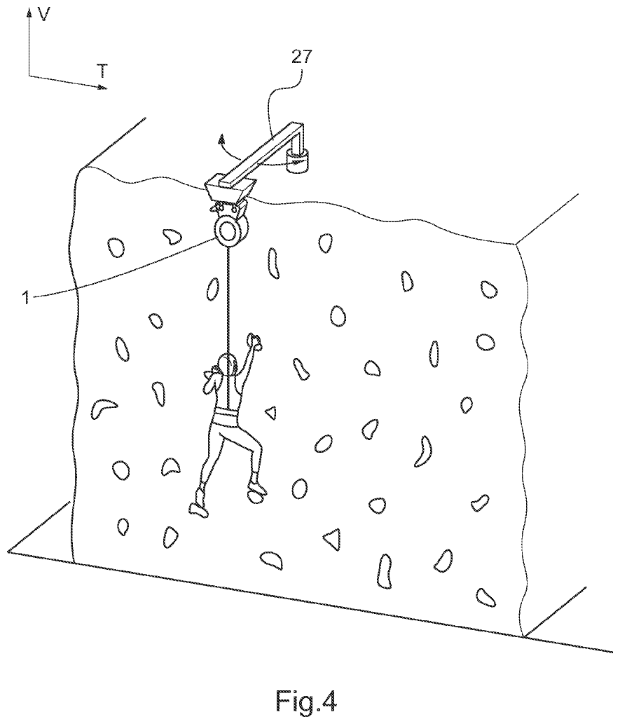

Furthermore, as described in more detail with reference to FIGS. 3 and 4, the device may be configured to enable a lateral movement of the belay, by virtue of a suitable mounting bracket which may have various configurations.

The device is equipped with an electrical supply connector 7, enabling the connection of a power cable 8. According to certain variants of the invention, the device may be equipped with a programming socket, which may be associated with or separate from the electrical supply 7.

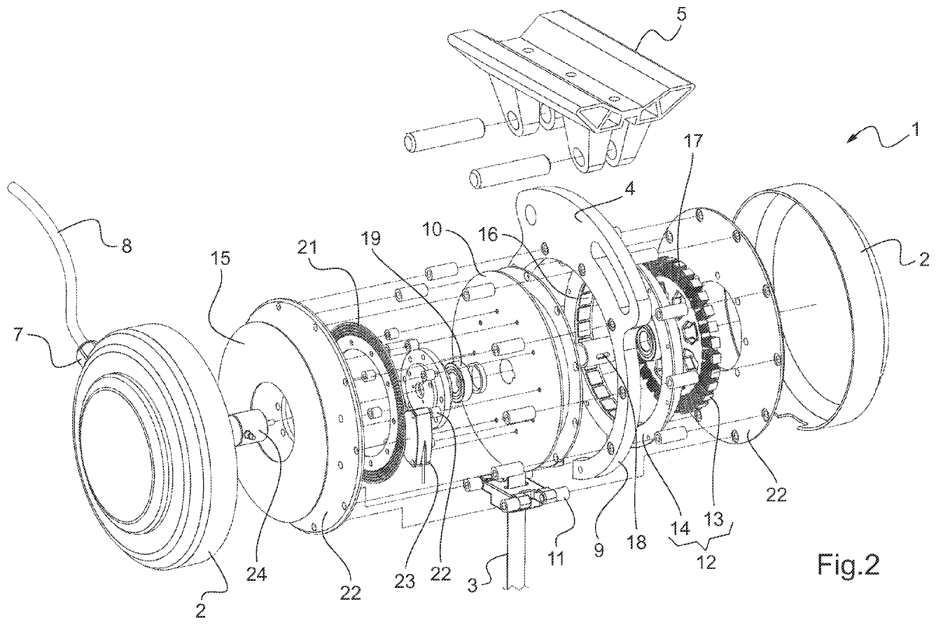

FIG. 2 shows an exploded view of the belay device according to the embodiment shown in FIG. 1, making it possible in particular to see the components inside the casing 2 of the belay 1.

An armature 9, which in the example shown here comprises the fastening interface 4, constitutes the main structure of the belay device. A pulley 10 enables the winding and unwinding of the rope 3, which here takes the form of flat webbing. A rope guide 11 enables the rope 3, to be guided, in particular for it to be properly wound on the pulley 10. The rope guide is typically a single piece, for example of plastics material, comprising a slot enabling the guided passage of the flat webbing constituting the rope 3.

The device comprises an electric motor 12 which comprises a rotor 14 and a stator 13. The operation of the motor is automatically controlled by an electronic control circuit 15.

The rotor 14 essentially consists of an annulus on an inside face of which are fastened permanent magnets 16. The permanent magnets 16 are advantageously powerful magnets, for example of neodymium. The stator 13 is positioned inside the annulus of the rotor 14. The stator 13 comprises a set of windings 17. The rotor and the stator form a brushless motor. This type of motor makes it possible to generate a high torque, and is very reliable and little subject to wear, in the absence of parts rubbing together. The motor 12, and in particular the rotor 14, is directly connected to the pulley 10 for example by nuts distributed over the perimeter of the pulley 10 and of the rotor 14. Thus, any rotational movement of the rotor 14 is directly transmitted to the pulley 10, and vice-versa.

The shaft 18 is rotationally coupled to the pulley 10 through use of a cotter. An encoder 24 is connected to the shaft 18, and thereby enables the rotation of the pulley 10 to be characterized.

The shaft is advantageously mounted on rolling bearings, in particular in relation to the stator 13. For example, two ball bearings 19 enable the free rotation of the shaft (and thus of the pulley 10 and of the rotor 13) in the belay.

The belay further comprises a disk 21, rigidly connected to the pulley 10 via spacers 22.

The disk 21, in cooperation with calipers 23, constitutes a disk brake enabling the pulley 10. to be rotationally braked or stopped. This brake may be actuated as a safety measure, for example in case of cutting off of the electrical supply of the belay device, for example to brake the rotation of the pulley in case of a fall by a climber belayed by the belay device.

The assembly constituted by the motor 12, the armature 9, the pulley 10 and the disk 21, is included between two flanges 22 fastened together via spacers, which are for example distributed on the periphery of the flanges 22.

In a variant, the disk 21 can serve as a coding wheel which makes it possible, using one or more optical sensors, to characterize the rotation (angle of rotation, and/or speed of rotation) of the pulley 10. The information on the rotation of the pulley 10 enables the speed of winding or unwinding of the rope 3 to be determined, in particular the linear speed of the rope entering or exiting the casing of the belay.

The electronic circuit 15 is positioned outside the mechanical part of the system located between the two flanges 22, but could according to other embodiments be located differently, in particular between the flanges 22.

Contrary to the known belay devices, the braking at the time of a fall of a climber belayed by the device is achieved by application to the pulley of an appropriate torque by the motor 12. Furthermore, the belay device enables assisted climbing, also by application of a torque to the pulley by the motor.

The use of a motor enables precise automatic control, dynamically, of the torque applied to the pulley according to various operating modes of the device and according to the force exerted by the rope 3 on the belay device.

In a fall mode, the belay device must limit the speed of the climber's fall to a safe speed, that is to say to a speed at which the climber is able to land without danger on the ground. A speed of 1.8 m/is, i.e. 6 feet per second, is considered suitable. The device may thus propose a fall speed, which may optionally be programmed, of 1 m/s, 1.8 m/s, 2 m/s, or 3 m/s, these values being given by way of non-limiting example.

For this fall mode, the torque to apply by the motor depends on the climber using the device as well as the geometry of the pulley, and in particular on its diameter. For blocking the fall, a torque is applied that applies to the rope a force opposite and equal to the force exerted by the climber (typically the climber's weight). For a given fall speed, the torque applied is modulated to maintain the maximum desired fall speed.

The automatically controlled motor can also enable dynamic belaying of the climber by dynamic management of the torque applied to the pulley. Typically, beyond a certain height climbed, which may be determined by the amount of rope 3 wound in the belay since the start of a climb, it may be more comfortable and safer for the climber not to suddenly stop their fall, but to provide progressive braking until an acceptable fall speed is attained. In the context of conventional belaying by a belayer located at the bottom of the face, this is achieved by providing a little slack in the rope before braking the climber's fall. Such behavior may be reproduced in automatic, programmed, manner by the belay device provided by the invention.

A fall situation may be detected by the unwinding of the rope 3, which gives rise to a given direction of rotation of the pulley 10. Alternatively, or by way of complement to this parameter, the acceleration of the rotation of the pulley and/or the torque or the variation in torque applied by the rope 3 on the pulley may be determined and employed.

One of the primary functions of an auto belay device is to enable the progressive winding of the rope during the ascent of the climber. The device provided makes it possible to satisfy this basic function, without giving assistance, that is to say without applying a traction force to the climber or at least without applying a significant traction force to the climber. Typically, the automatically controlled motor may be programmed to wind the rope with a very weak torque applied to the pulley, and/or be programmed to stop its winding as soon as the reaction of the rope 3 on the pulley 10 increases.

The belay device also makes it possible to provide assisted climbing, in an assistance mode, by traction on the rope 3. For the climber, such traction reduces his or her apparent weight; and facilitates ascension. The motor may be automatically controlled, and programmed, so as to dynamically adapt the aid provided, according to various laws or various parameters.

The climber may wish for assistance in the context of sports climbing training, for example to modulate effort in a training program, to work his or her climbing technique without the constraint of high effort, or on passages or sequences that are physically demanding. In these cases and others, continuous traction on the rope may prove to be a hindrance or undesirable. The device makes it possible to apply a traction merely as assistance to an effort, that is to say to ensure that assistance is only provided in response to an effort by the climber, and is modulated according to the detected effort.

For example, the application of traction to the rope by the motor may be limited to situations in which the automatic control device, via an encoder, detects a rotation of the pulley resulting from a reduction in the force applied by the rope on the pulley. The reduction, relative to an initial or reference situation, corresponds to the fact that by climbing, the climber applies part of his or her weight to the holds or more generally part of the weight he or she exerted on the rope, and therefore creates an effort tending to hoist him or her.

As the force applied by the pulley is the resultant of the force exerted by the climber and the reaction of the rope to the force which the pulley applies to it, this force corresponds at all times to the weight of the climber less the portion of that weight borne by the climbing holds, and may at any time be compared with a predefined value to determine whether the climber is in course of climbing or not. Thus, the assistance can optionally be provided only when the climber makes an effort, in the same way, by analogy, as do assistance devices of electric bicycles which only provide help when pedaling is detected.

The reduction in the force applied by the rope on the pulley may be described by several parameters, in particular the absolute value of this reduction, by its ratio compared with an initial value, or by its speed. These parameters may be determined by the observation of the rotation of the pulley. These parameters may furthermore be combined, one with another or all three together, to determine the level of assistance to apply. The level of assistance is advantageously dynamically modulated as a function of the change in one or more of these parameters.

In particular, the assistance may optionally be provided only when a sufficient, predefined, disparity is identified between the force exerted by the rope on the pulley and a reference force. This disparity makes it possible to assist the climber only starting from a certain level of effort provided. This makes it possible to avoid inadvertent implementation of the assistance. This may also make it possible to define for example a constant value of an effort to produce by the climber, the difference between that value and the force required for the climb being provided by the assistance function of the belay device.

The assistance given may also take into account a calibration value. This value may be fixed, by default, or be programmed according to the user. For example, the weight of the user, or a predefined fraction of the user's weight, may be taken as calibration value.

Other laws for automatic control of the motor may be envisioned under the invention. For example, the motor may be automatically controlled such that the climb speed of the climber is constant. This type of assistance is little adapted to the practice of sports climbing, but may, in certain cases, be appropriate for a climbing activity for amusement.

FIG. 3 illustrates a belay device for climbing, in accordance with an embodiment of the invention. According to this embodiment, the belay may translationally move laterally at the top of the climbing face 25 to accompany a lateral translational movement of the belayed climber.

The transverse direction T is defined as a direction perpendicular to the vertical V, that is to say the direction of application of gravity or for instance the general direction of extension of the belaying rope. The transverse direction extends in the general plane of extension of the climbing face considered.

In the embodiment of FIG. 3, the auto belay 1 is mounted via a suitable mounting bracket 5 on a rail 26 extending in the transverse direction T. The auto belay moves freely on the rail 26, such that its movement accompanies the lateral translational movements of the climber.

FIG. 4 illustrates a variant of the principle illustrated in FIG. 3. In the embodiment of FIG. 4, the auto belay 1 providing an assisted climbing function is mounted on a pivoting arm 27, which enables its transverse movement. Although the movement is not purely transverse, the device may be configured to enable adequate transverse translational movement, and has the advantage of high simplicity and high reliability.

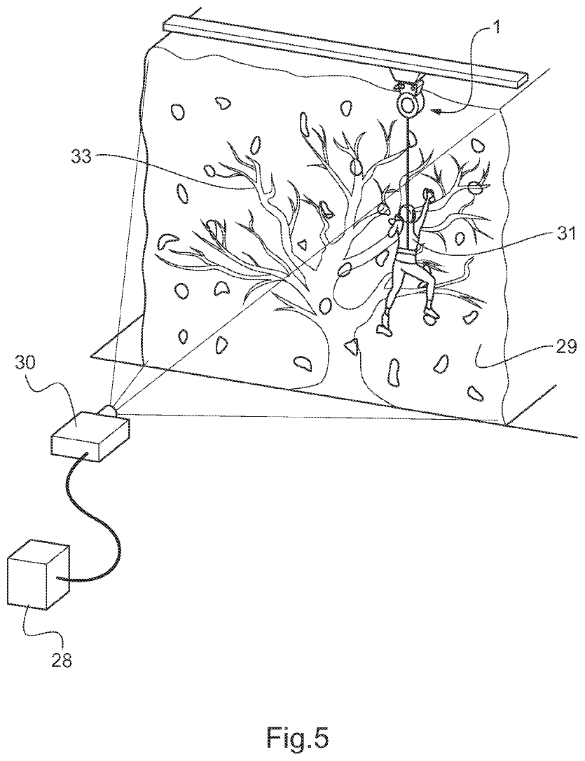

FIG. 5 illustrates another aspect of the invention, according to which the belay device enabling assisted climbing is employed in a virtual or augmented reality environment. More particularly, due to the assistance that can be provided, as well as the comfort and high level of safety given, the belay device provided is particularly suited to uses that are more for amusement than the conventional practice of climbing.

The invention thus also relates to a climbing system for amusement shown in FIG. 5. In addition to the belay device comprising an auto belay 1, the device comprises a computer system 28 programmed to apply a virtual environment to a climbing structure 29 (for example a climbing wall).

The virtual environment may be applied by means of a projector 30. This is then referred to as augmented reality.

The environment may be applied via a virtual reality headset 31, and this is then referred to as virtual reality.

The projector and the virtual reality headset may be employed alternatively or in complementary manner, for example to enable the concomitant immersion of the climber in the virtual environment and viewing by spectators of the virtual environment in which the climber is placed.

The virtual environment may be for any type, for example a natural environment (cliff, virtual tree 33, etc.) or an urban environment (facade of a building, monument, etc.).

The virtual environments are advantageously created such that the holds of the virtual environment match, in position and form, the real holds of the climbing structure 29.

The ensemble may comprise means making it possible to render the virtual environment dynamic, according to the actions of the climber. For this, sensors enable the position and the attitude of the climber to be determined. They may be sensors positioned on the climber, and/or may be one or more cameras associated with image processing software. It is thus possible to vary the environment that is projected on the climbing structure 29 or in virtual reality headgear, to adapt it to certain actions of the climber. It is also possible to supply visual feedback to the climber equipped with a virtual reality headset on the position of his or her own limbs in the virtual environment.

A climbing system for amusement as provided according to this aspect of the invention makes it possible to offer a new climbing experience that is amusing or has a pedagogical vocation (for example for adaptation to the sensation of vertigo) or even an experience entirely for amusement: climbing without effort in strange virtual environments, jumps between virtual trees, between virtual buildings, etc., for example in the manner of a super hero capable of superhuman physical prowess.

The belay device for climbing developed in the invention thus provides an auto belay device which is simple and safe, for the practice of climbing without a belayer. It makes it possible, by one and the same means, i.e. a motor automatically controlled using an encoder coupled to the pulley of the belay, to perform both a function of belaying in case of a fall, and a function of assisted climbing. Thus use of an automatically controlled motor makes it possible to obtain the necessary torque to apply to the pulley for these two functions, and enables the modulation of that torque according to various laws for automatic control of the motor, in order to satisfy the uses and purpose of the device in the practice of climbing as sport, leisure, or amusing activity.

By its very simple configuration and the functions it offers, the device is adapted to be employed in a climbing ensemble for amusement, enabling a virtual environment to be applied to a real climbing structure, to provide new and/or amusing experiences to the climber.

1. Belay device for climbing comprising an auto belay comprising a pulley and a rope, the device being configured such that the rope is wound or unwound according to the movements of a climber belayed by said belay device, the belay device comprising:
an electric motor configured so as to be able to apply a torque to the pulley and an encoder coupled to the pulley, the motor being automatically controlled by an electronic control circuit using the encoder as a function of the rotation of the pulley so as to modulate said torque applied to the pulley according to at least:
an assistance mode in which the torque applied by the motor to the pulley gives rise to traction of the rope which assists the climber in his or her climb; and
a fall mode in which the torque applied by the motor to the pulley blocks a fall of the climber or slows the fall to maintain at a speed less than 3 m/s.

2. Device according to claim 1, wherein the motor is automatically controlled such that the torque giving rise to the traction in the assistance mode is only applied when the encoder detects a rotation of the pulley which shows a reduction in the force applied by the rope on the pulley.

3. Device according to claim 2, wherein the value of the torque applied by the motor to the pulley in the assistance mode is a function of the value, rate, or the speed of the reduction in the force applied by the rope on the pulley.

4. Device according to claim 1, wherein the value of the torque applied by the motor to the pulley in the assistance mode is a function of a predefined calibration value of the device.

5. Device according to claim 1, wherein the motor is automatically controlled such that, in the assistance mode, the speed of ascent, corresponding to the winding speed of the rope on the pulley, is substantially constant.

6. Device according to claim 1, wherein the motor is automatically controlled such that in the fall mode the torque applied to the pulley for the most part ensures a substantially uniform predefined fall speed, independently of the applied by the rope on the pulley.

7. Device according to claim 6, wherein the motor is automatically controlled such that in the fall mode the torque applied to the pulley enables progressive braking of the climber before ensuring a substantially uniform fall speed.

8. Device according to claim 1, wherein the motor is directly linked to the pulley or via a synchronous mechanical transmission.

9. Device according to claim 1, for comprising a disk brake configured to be automatically actuated in case of electrical power cut of said device.

10. Device according to claim 1, wherein the motor is of brushless type and comprises a rotor bearing a series of permanent magnets and a stator bearing a set of windings.

11. Device according to claim 1, further comprising a mechanical system enabling movement of the auto belay, in a direction referred to as transverse, perpendicular to the general direction of extension of the rope outside the auto belay referred to as vertical.

12. Device according to claim 11, wherein the auto belay is mounted on a rail extending in the transverse direction so as to be able to be translationally moved freely along said rail, or on an arm pivoting about an axis extending substantially in the vertical direction.

13. Climbing system for amusement comprising a climbing structure, a virtual reality device, a computer system configured to project, into the virtual reality device, an image applied to the structure, to climb, and a belay device for climbing in accordance with claim 1.

14. Climbing system for amusement comprising a climbing structure, an augmented reality device, a computer system configured to project an image onto the structure to climb, and a belay device for climbing in accordance with claim 1.

15. Climbing system for amusement according to claim 13 comprising a sensor configured to determine the position and attitude of a climber using said climbing system for amusement, so as to vary the image projected in the virtual reality device or on the structure to climb.

16. Device according to claim 2, wherein the value of the torque applied by the motor to the pulley in the assistance mode is a function of a predefined calibration value of the device.

17. Device according to claim 3, wherein the value of the torque applied by the motor to the pulley in the assistance mode is a function of a predefined calibration value of the device.

18. Device according to claim 2, wherein the motor is automatically controlled such that, in the assistance mode, the speed of ascent, corresponding to the winding speed of the rope on the pulley, is substantially constant.

19. Device according to claim 3, wherein the motor is automatically controlled such that, in the assistance mode, the speed of ascent, corresponding to the winding speed of the rope on the pulley, is substantially constant.

20. Device according to claim 4, wherein the motor is automatically controlled such that, in the assistance mode, the speed of ascent, corresponding to the winding speed of the rope on the pulley, is substantially constant.
